(19) United States
(12) Patent Application Publication
(10) Pub. No.: US 2025/0256801 A1
(43) Pub. Date: Aug. 14, 2025

(54) BICYCLE BRAKING DEVICE AND METHOD

(71) Applicants: Arun M. Wylie, Seattle, WA (US); Henry H. Wylie, Seattle, WA (US)

(72) Inventors: Arun M. Wylie, Seattle, WA (US); Henry H. Wylie, Seattle, WA (US)

(21) Appl. No.: 18/436,532

(22) Filed: Feb. 8, 2024

(51) Int. Cl. B62L 1/04

(52) U.S. Cl. CPC B62L 1/04

(57) ABSTRACT

A bicycle braking device and associated methods are disclosed. In one example, the bicycle braking device includes an elongated contact surface for actuation by a user, where the elongated contact surface can be pressed against a bicycle tire to slow or stop the bicycle. In selected examples, the bicycle braking device includes a replaceable brake pad with high friction and wear properties.

### TECHNICAL FIELD

Embodiments described herein generally relate to bicycles, bicycle braking devices and associate methods.

### BACKGROUND

Bicycles are a popular vehicle for transportation and recreation. One type of recreation includes freestyle riding where tricks or maneuvers are performed. Often the maneuvers are performed at a park or area designated for bicycles, skateboards, etc. Conventional bicycle brakes often require cables between a brake lever on a handlebar and a brake caliper at a given wheel of the bicycle. When used for trick riding, the cables can inhibit some desired tricks. For example, spinning the handlebars around more than 180 degrees may be difficult or impossible with many cable brake configurations. As a result, many freestyle riders choose to not use brakes when performing tricks. Additionally, freestyle bike riding is often hard on bicycle equipment. Forces involved in many tricks are high, and components of the bicycle may be damaged by the trick itself, or any crashes that may be sustained when working on a trick.

It is desired to have the ability to reliably slow or stop a freestyle bicycle with a durable device that can withstand the rigors of practicing and performing tricks. A bicycle braking device is desired that address these concerns, and other technical challenges.

### BRIEF DESCRIPTION OF THE DRAWINGS

FIG. 1 shows a bicycle with a braking device in accordance with some example embodiments.

FIG. 2 shows a bicycle braking device in accordance with some example embodiments.

FIG. 3 shows a close up view of selected components of a bicycle braking device in accordance with some example embodiments.

FIG. 4A shows an end view of a bicycle braking device in accordance with some example embodiments.

FIG. 4B shows a top view of the bicycle braking device from FIG. 4A in accordance with some example embodiments.

FIG. 4C shows a side view of the bicycle braking device from FIG. 4A in accordance with some example embodiments.

FIG. 5 shows a close up view of a brake pad of a bicycle braking device in accordance with some example embodiments.

FIG. 6A shows a component of a bicycle frame attachments of a bicycle braking device in accordance with some example embodiments.

FIG. 6B shows another component of a bicycle frame attachments of a bicycle braking device in accordance with some example embodiments.

FIG. 7 shows another bicycle braking device in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

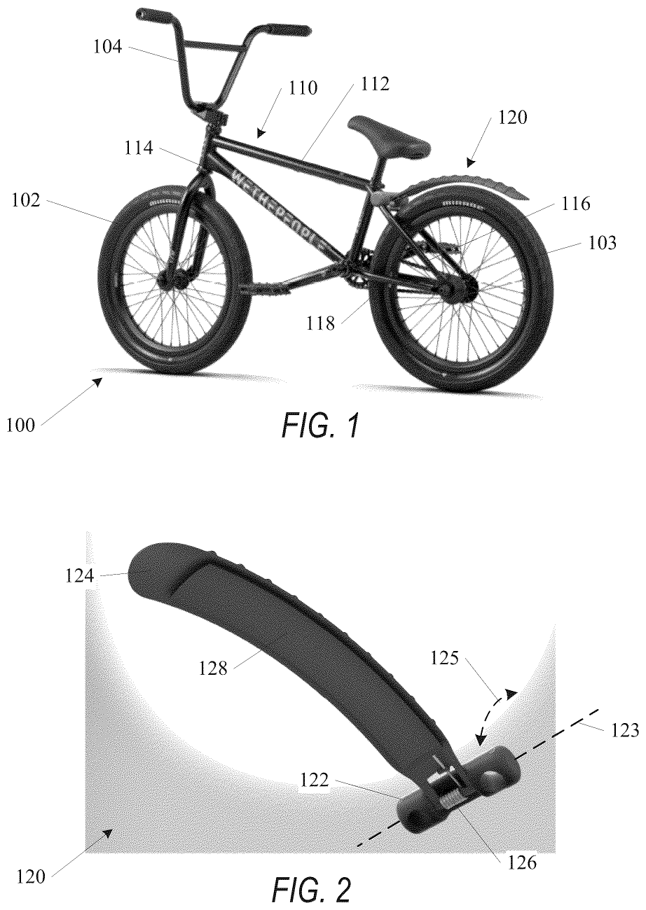

FIG. 1 shows a bicycle 100. The bicycle 100 includes a pair or wheels 102, handlebars 104, and a frame 110. The frame 110 includes a top tube 112, a downtube 114, seat stays 116, and chain stays 118. A braking device 120 is included in the bicycle 100 of FIG. 1. In the example shown, the braking device 120 is coupled to the bicycle frame 110 in a location adjacent to a tire 103 of the rear wheel 102.

In one example, the bicycle 100 is a freestyle bicycle that is used for performing tricks. In freestyle bicycle riding, traditional bicycle brakes are often not practical, as they can get in the way of the rider, and may prohibit certain motions of the bicycle during tricks. However, control over speed is desirable during use.

In one example, the braking device 120 is pivotally connected to the bicycle frame 110 at an axis of rotation. In one example method of use, pressing on the braking device with a foot or other body part causes components of the braking device 120 to rotate, and make frictional contact with the tire 103. In one example, the frictional contact causes a braking force that slows down the bicycle. When slowing or stopping is no longer desired, the user removes their foot or other body part from the braking device 120, and the tire 103 and wheel 102 are again free to rotate. More detailed description of the components and operation of the braking device 120 is provided in examples below.

FIG. 2 shows the braking device 120 from FIG. 1. A bicycle frame attachment 122 is shown. An extended contact surface 124 is shown, pivotally connected to the bicycle frame attachment 122 at an axis of rotation 123. In one example, the extended contact surface 124 includes a curved surface. In one example, the curved surface is configured to follow a diameter of a bicycle wheel. This provides improved frictional contact between the extended contact surface 124 and a bicycle tire.

The extended contact surface 124 has a range of motion 125 about the axis of rotation 123. A biasing device 126 is shown coupled between the extended contact surface 124 and the bicycle frame attachment 122 to urge the extended contact surface 124 toward a first location within the range of motion 125. In operation, the first location is a location that is away from the tire 103, but only at a close distance, so that when a user applies their foot or other body part to a backside of the extended contact surface 124, the extended contact surface 124 is able to quickly make frictional contact with the tire 103.

The braking device 120 of FIG. 2 further shows a brake pad 128 attached to a bottom of the extended contact surface 124. In one example, the brake pad 128 is formed from a material that provides a desired level of friction with the tire 103. In one example, the brake pad 128 is formed from a material that provides a low wear rate. In one example, the brake pad 128 is formed from a material that reduces damage to the tire 103. These properties may not be the same as the material chosen for the extended contact surface 124. In one example, the brake pad 128 includes copper. Copper provides a number of advantages, including high heat dissipation from friction. In one example, the brake pad 128 includes ceramic material. Examples of ceramic material include, but are not limited to, a composite that includes ceramic powder, sintered ceramic solids, etc. Ceramic material provides a number of advantages, including high heat resistance from friction, and high wear resistance. In one example, the brake pad 128 includes a polymer material. One example of a polymer material includes a silicone material. Polymer material provides a number of advantages, including resilient deformation that can be useful for attachment and replacement as discussed in more detail below. Silicone material provides a number of advantages, including high heat resistance from friction.

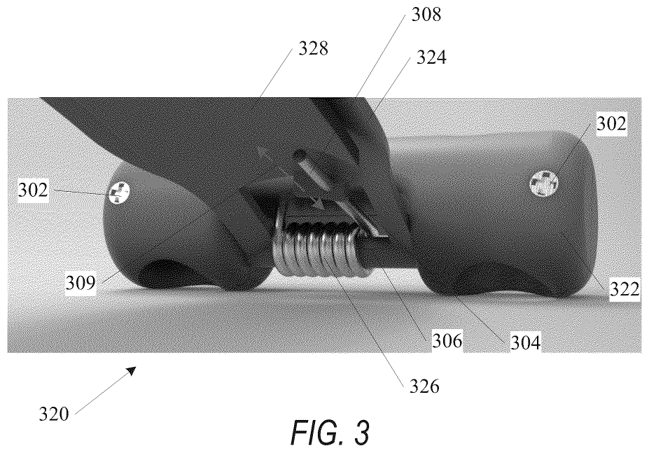

FIG. 3 shows a close-up view of selected components of a bicycle braking device 320, similar to the bicycle braking device 120 from FIGS. 1 and 2. An extended contact surface 324 is shown coupled to a bicycle frame attachment 322. A brake pad 328 is included in the example of FIG. 3. In one example, the bicycle frame attachment 322 includes a pair of split body members that are secured together using fasteners 302. Details of the split body members are discussed in more detail below.

FIG. 3 shows a close-up view of a biasing device 326 similar to the biasing device 126 from FIG. 2. In the example shown, the biasing device 326 includes a spring. In one example the biasing device 326 includes a metallic spring, although other materials, such as carbon fiber, polymers, etc. are also within the scope of the invention. Metallic springs may include steel, stainless steel, aluminum, etc. Stainless steel provides a number of advantages, including high resistance to corrosion.

In one example the biasing device 326 includes a torsion spring, although the invention is not so limited. Other spring configurations, such as coil springs, extension springs, compression springs, leaf springs, flat springs, etc. are also within the scope of the invention. In the example of FIG. 3, the biasing device 326 includes a torsion spring that is located on a hinge portion 306. In one example, the hinge portion 306 is integrally molded with the extended contact surface 324. The hinge portion 306 defines an axis of rotation of the extended contact surface 324, as shown with axis 123 in the example of FIG. 2. The example of FIG. 3 further includes a spring retainer 304 that engages with an end 308 of the torsion spring 326. In on example, the spring retainer 304 is integrally molded with the extended contact surface 324.

Integral molding simplifies construction, reduces cost, and provides a robust construction of the bicycle braking device 120. In one example, the extended contact surface 324 and associated integrally molded components are formed from acrylonitrile butadiene styrene (ABS) polymer. Other polymers are also within the scope of the invention, although ABS provides a high level of toughness at a low manufacturing cost.

In the example of FIG. 3, the spring retainer 304 is configured to both secure the end 308 of the torsion spring 326 and to allow a linear degree of freedom 309 of the end 308 of the spring 326. In operation, as the extended contact surface 324 pivots, the linear degree of freedom 309 of the end 308 of the spring 326 allows the biasing force to be applied, while still permitting motion of the contact surface 324.

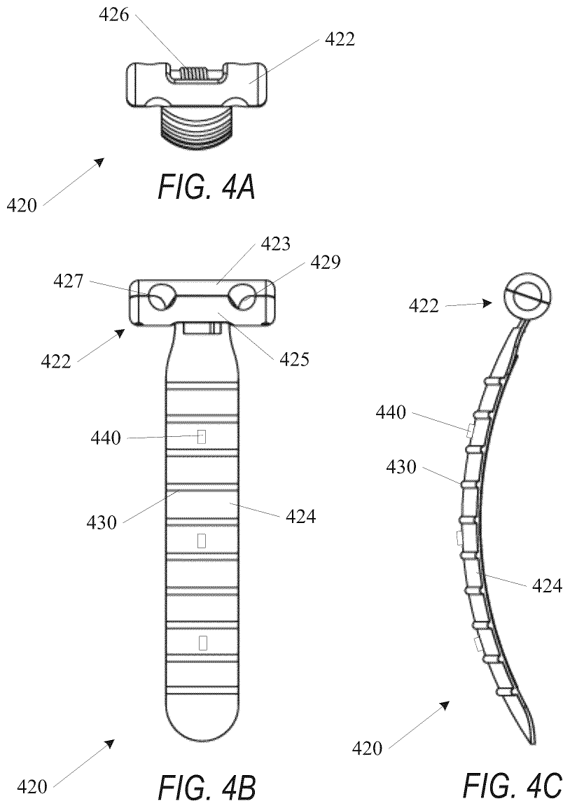

FIGS. 4A-4C show three views of a bicycle braking device 420, similar to the bicycle braking device 120 from FIGS. 1 and 2. In FIG. 4A, an end view shows a bicycle frame attachment 422 and a biasing device 426. In FIG. 4B, a top view shows the bicycle frame attachment 422 including a first split body member 423 and a second split body member 425. The first split body member 423 and the second split body member 425 are coupled together to define a pair of seat stay openings 427, 429. In operation, the pair of seat stay openings 427, 429 correspond to a size and angle of seat stays 116 as shown in FIG. 1. Although seat stay mounting is shown in selected examples, the invention is not so limited. Other frame members, or other bicycle components can also be used to mount the bicycle braking device 420. Examples include, but are not limited to, seats, seatposts, brake bridges, top tubes, etc.

FIG. 4B further shows one or more ridges 430 on a user side of an extended contact surface 424. In operation, the one or more ridges 430 provide additional traction to help keep a user's foot or other body part in place while applying braking pressure to the extended contact surface 424. Although ridges are shown, other structures, such as an abrasive surface finish, a number of bumps, etc. are possible structure to help engage a user's foot, etc.

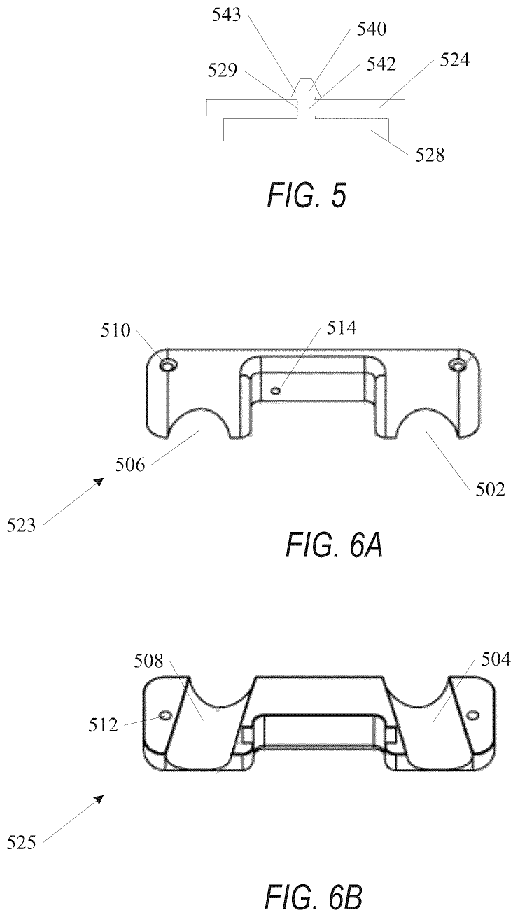

FIG. 4B also shows a number of attachment devices 440. In one example, the attachment device 440 are configured to secure a brake pad to the extended contact surface 424. Fasteners, such as screws, nuts, etc. are possible attachment devices 440. In one example, an attachment device 440 includes an integrally molded attachment device 440, and a brake pad is replaceable without the use of tools. One example of an integrally molded attachment device 440 is shown in more detail in FIG. 5.

FIG. 4C shows a side view of the bicycle frame attachment 422 including the bicycle frame attachment 422, the extended contact surface 424, and the one or more ridges 430. A portion of the attachment devices 440 is also shown extending above a top surface of the extended contact surface 424. FIG. 5 shows one example of an attachment device 540. A brake pad 528 is shown with an integrally formed protrusion 542 and a head portion of the attachment device 540. In the example shown, a bayonet configuration 543 is used. In use, the bayonet configuration 543 is deformed as it passes through a hole 529 in the extended contact surface 524. The bayonet configuration 543 then springs back to its original shape, larger than the hole 529. In this manner, the brake pad 528 can be attached to the extended contact surface 524 without the use of tools. Any deformable material can be utilized for the attachment device 540 to provide an attachment without tools. As noted above, suitable materials include, but are not limited to, polymers, metals, etc. One example includes a silicone polymer that is deformable, and has high heat resistance.

FIGS. 6A and 6B show additional detail of a frame attachment (122, 322, 422) that includes a pair of split body members. A first split body member 523 is shown in FIG. 6A, and a second split body member 525 is shown in FIG. 6B. The split body members 523, 525 define a pair of seat stay openings. A first opening part 502 and a second opening part 504 come together to form a first seat stay opening. A third opening part 506 and a fourth opening part 508 come together to form a second seat stay opening. In one example, engaging two seat stays provides better stability and a more secure connection for the bicycle braking device. In the example of FIG. 6A, a second spring holder 514 is included for a second end of a spring 326 as shown in FIG. 3. Holes 510 and 512 are included in the example of FIGS. 6A and 6B to accommodate fasteners such as fasteners 302, although other coupling methods are within the scope of the invention.

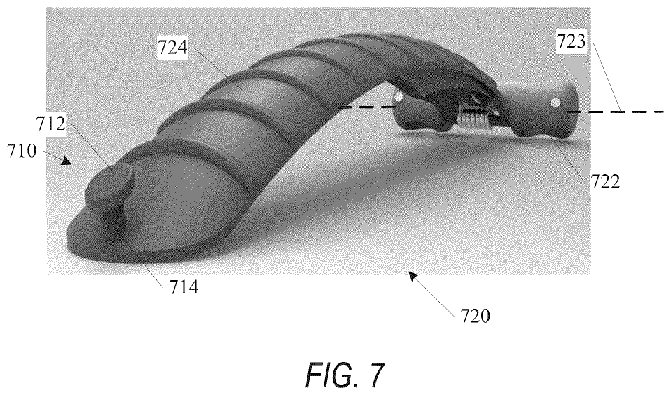

FIG. 7 shows another braking device 720 similar to the braking device 120 from FIG. 1. A bicycle frame attachment 722 is shown. An extended contact surface 724 is shown, pivotally connected to the bicycle frame attachment 722 at an axis of rotation 723. In the Example of FIG. 7, an accessory post 710 is further provided. In one example, the accessory post 710 is integrally molded with the extended contact surface 724, although the invention is not so limited. Integral molding provides increased strength to the accessory post 710 and reduced manufacturing cost. In one example, the accessory post 710 is configured to attach a bicycle light.

In the example shown, the accessory post 710 includes an attachment section 714 and a retainer 712. In one example, the attachment section 714 is dimensioned within a range of possible diameters to approximate a commercial bicycle seat post. In one example, a range of diameters is between 25 mm and 30 mm in diameter. A number of commercially available bicycle lights are designed to mount to a seatpost. By configuring the attachment section 714 to approximate a seatpost, easy attachment of existing bicycles lights is facilitated. In selected configurations, the retainer 712 is further included as a wider portion above the attachment section 714. In operation, the inclusion of a retainer 712 helps to keep an attached bicycle light from sliding upwards and falling off the accessory post 710.

To better illustrate the method and apparatuses disclosed herein, a non-limiting list of embodiments is provided here:

Example 1. A bicycle braking device, comprising: a bicycle frame attachment; an extended contact surface, pivotally connected to the bicycle frame attachment at an axis of rotation, the extended contact surface having a range of motion about the axis of rotation; a biasing device coupled between the extended contact surface and the bicycle frame attachment to urge the extended contact surface toward a first location within the range of motion.

Example 2. The bicycle braking device of Example 1, further including a brake pad attached to a bottom of the extended contact surface.

Example 3. The bicycle braking device of Example 2, wherein the brake pad includes copper.

Example 4. The bicycle braking device of Example 2, wherein the brake pad includes a ceramic.

Example 5. The bicycle braking device of Example 2, wherein the brake pad includes silicone.

Example 6. The bicycle braking device of Example 5, wherein the brake pad includes an integrally molded attachment device, and the brake pad is replaceable without use of tools.

Example 7. The bicycle braking device of Example 1, wherein the bicycle frame attachment includes a pair of split body members, when coupled together along a split seam, the split body members defining a pair of seat stay openings.

Example 8. The bicycle braking device of Example 1, wherein the extended contact surface includes a curved surface.

Example 9. The bicycle braking device of Example 1, wherein the extended contact surface includes one or more ridges.

Example 10. The bicycle braking device of Example 1, wherein the extended contact surface includes an ABS polymer; and an integrally molded hinge portion.

Example 11. The bicycle braking device of Example 10, wherein the biasing device includes a metal spring.

Example 12. The bicycle braking device of Example 11, wherein the extended contact surface includes an integrally molded spring retainer.

Example 13. The bicycle braking device of Example 12, wherein the spring retainer is configured to allow a linear degree of freedom of an end of the metal spring.

Example 14. The bicycle braking device of Example 1, further including an accessory post located at an end of the extended contact surface.

Example 15. A bicycle, comprising: a pair of wheels attached to a bicycle frame, the frame including; a top tube; a down tube; chain stays; seat stays; a braking device, including; a bicycle frame attachment coupled to the frame; an extended contact surface, pivotally connected to the bicycle frame attachment at an axis of rotation, the extended contact surface having a range of motion about the axis of rotation; and a biasing device coupled between the extended contact surface and the bicycle frame attachment to urge the extended contact surface toward a first location within the range of motion, wherein the first location is spaced away from a rear tire of the pair of wheels.

Example 16. The bicycle of Example 15, wherein the bicycle frame attachment is coupled to the frame at a location on the seat stays.

Example 17. The bicycle of Example 16, wherein the bicycle frame attachment is coupled to both seat stays of the frame.

Example 18. The bicycle of Example 15, further including a brake pad attached to a bottom of the extended contact surface.

Example 19. The bicycle of Example 18, wherein the brake pad includes a polymer.

Example 20. The bicycle of Example 19, wherein the brake pad includes an integrally molded attachment device, and the brake pad is replaceable without use of tools.

Example 21. The bicycle of Example 20, wherein the extended contact surface includes one or more ridges.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims.

The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A bicycle braking device, comprising:
a bicycle frame attachment;
an extended contact surface, pivotally connected to the bicycle frame attachment at an axis of rotation, the extended contact surface having a range of motion about the axis of rotation;
a biasing device coupled between the extended contact surface and the bicycle frame attachment to urge the extended contact surface toward a first location within the range of motion.

2. The bicycle braking device of claim 1, further including a brake pad attached to a bottom of the extended contact surface.

3. The bicycle braking device of claim 2, wherein the brake pad includes copper.

4. The bicycle braking device of claim 2, wherein the brake pad includes a ceramic.

5. The bicycle braking device of claim 2, wherein the brake pad includes silicone.

6. The bicycle braking device of claim 5, wherein the brake pad includes an integrally molded attachment device, and the brake pad is replaceable without use of tools.

7. The bicycle braking device of claim 1, wherein the bicycle frame attachment includes a pair of split body members, when coupled together along a split seam, the split body members defining a pair of seat stay openings.

8. The bicycle braking device of claim 1, wherein the extended contact surface includes a curved surface.

9. The bicycle braking device of claim 1, wherein the extended contact surface includes one or more ridges.

10. The bicycle braking device of claim 1, wherein the extended contact surface includes an ABS polymer; and
an integrally molded hinge portion.

11. The bicycle braking device of claim 10, wherein the biasing device includes a metal spring.

12. The bicycle braking device of claim 11, wherein the extended contact surface includes an integrally molded spring retainer.

13. The bicycle braking device of claim 12, wherein the spring retainer is configured to allow a linear degree of freedom of an end of the metal spring.

14. The bicycle braking device of claim 1, further including an accessory post located at an end of the extended contact surface.

15. A bicycle, comprising:
a pair of wheels attached to a bicycle frame, the frame including;
a top tube;
a down tube;
chain stays;
seat stays;
a braking device, including;
a bicycle frame attachment coupled to the frame;
an extended contact surface, pivotally connected to the bicycle frame attachment at an axis of rotation, the extended contact surface having a range of motion about the axis of rotation; and
a biasing device coupled between the extended contact surface and the bicycle frame attachment to urge the extended contact surface toward a first location within the range of motion, wherein the first location is spaced away from a rear tire of the pair of wheels.

16. The bicycle of claim 15, wherein the bicycle frame attachment is coupled to the frame at a location on the seat stays.

17. The bicycle of claim 16, wherein the bicycle frame attachment is coupled to both seat stays of the frame.

18. The bicycle of claim 15, further including a brake pad attached to a bottom of the extended contact surface.

19. The bicycle of claim 18, wherein the brake pad includes a polymer.

20. The bicycle of claim 19, wherein the brake pad includes an integrally molded attachment device, and the brake pad is replaceable without use of tools.

21. The bicycle of claim 20, wherein the extended contact surface includes one or more ridges.
